(19) United States
(12) Patent Application Publication
(10) Pub. No.: US 2004/0172371 A1
(43) Pub. Date: Sep. 2, 2004

(54) Automated negotiation

(75) Inventors: Madoka Mitsuoka, Sunnyvale, CA (US); Kenji Nagahashi, Sunnyvale, CA (US); David L. Marvit, San Francisco, CA (US); Hitoshi Matsumoto, San Jose, CA (US); B. Thomas Adler, Menlo Park, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 10/376,822

(22) Filed: Feb. 28, 2003

(51) Int. Cl. G06F 17/60

(52) U.S. Cl. 705/80

(57) ABSTRACT

A system supports automated negotiations between any number of appropriately enabled computing devices. These devices provide for automated negotiation of potential transactions using an iterative process in which multiple proposal are exchanged between negotiating parties.

### TECHNICAL FIELD OF THE INVENTION

The present invention relates generally to negotiations and, more particularly, to automated negotiations.

### BACKGROUND OF THE INVENTION

For many types of transactions, the cost of negotiations drives the nature of the transactions. For example, in developing countries with very low labor costs—where time is cheap, extended negotiations are virtually free. Therefore, transactions in these types of economies often involve haggling. In developed countries with higher labor costs, negotiations are often limited to high dollar transactions, while other transactions typically involve take it or leave it terms. However, making negotiations available in a wider variety of transactions can enable more effective dealings.

### SUMMARY OF THE INVENTION

In accordance with the present invention, techniques for automating negotiations are provided. According to particular embodiments, a system includes multiple negotiating parties, with each party capable of participating in an iterative negotiation process by exchanging multiple proposals.

According to one embodiment, a method for performing automated negotiations determines a value function for evaluating terms for a potential transaction and generates multiple proposals, with each of the generated proposals specifying terms for the potential transaction and with each of the terms having an associated status. The method communicates the generated proposals to a remote negotiation party and receives multiple proposals from the remote negotiation party, with each of the received proposals specifying terms for the potential transaction and with each of the terms in the received proposals having an associated status. The method identifies one or more acceptable ones of the received proposals, evaluates each of the acceptable proposals using the value function to determine relative values for each of the acceptable proposals, and selects one of the identified acceptable proposals based on the relative values. The method accepts the selected proposal by modifying the associated status for at least one of the terms in the selected proposal and communicates the accepted proposal to the remote negotiation party.

Embodiments of the invention provide various technical advantageous. By providing an automated system for negotiating transactions, the system increases the availability of negotiations. The increased availability of negotiations can lower transaction costs and, therefore, can increase the probability of successful transactions.

Also, the automated nature of negotiations can enable increases in the complexity of the negotiations. To support complex negotiations, particular embodiments enable evaluation of multi-parameter proposals using automated value functions. For example, a negotiation engine may use a value function capable of evaluating variations in many different parameters, such as price, quantity, delivery date, and product type. By permitting multi-parameter negotiations, the system can increase the likelihood of finding a deal beneficial to all parties.

The automated nature of negotiations enabled by this system also permits brute force, iterative negotiations. For example, a negotiation engine may quickly explore thousands of potential proposals from one or more other negotiation engines. The negotiation engines may then use any one of these various proposals as springboards for new proposals or for a final, accepted proposal. Thus, the automated negotiations enable quick, effective negotiations between any number of parties.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a system that includes negotiation parties capable of performing automated negotiation in accordance with particular embodiments of the present invention;

FIG. 2 is a block diagram illustrating information flow for supporting automated negotiations between a buyer and a seller in the system;

FIGS. 3A, 3B, 3C, 3D and 3E are diagrams illustrating proposals exchanged between a buyer and seller during example negotiations;

FIG. 4 is a block diagram illustrating elements of an exemplary negotiating party from the system; and

FIG. 5 is a flowchart illustrating a method for performing automated negotiations.

### DETAILED DESCRIPTION OF THE DRAWINGS

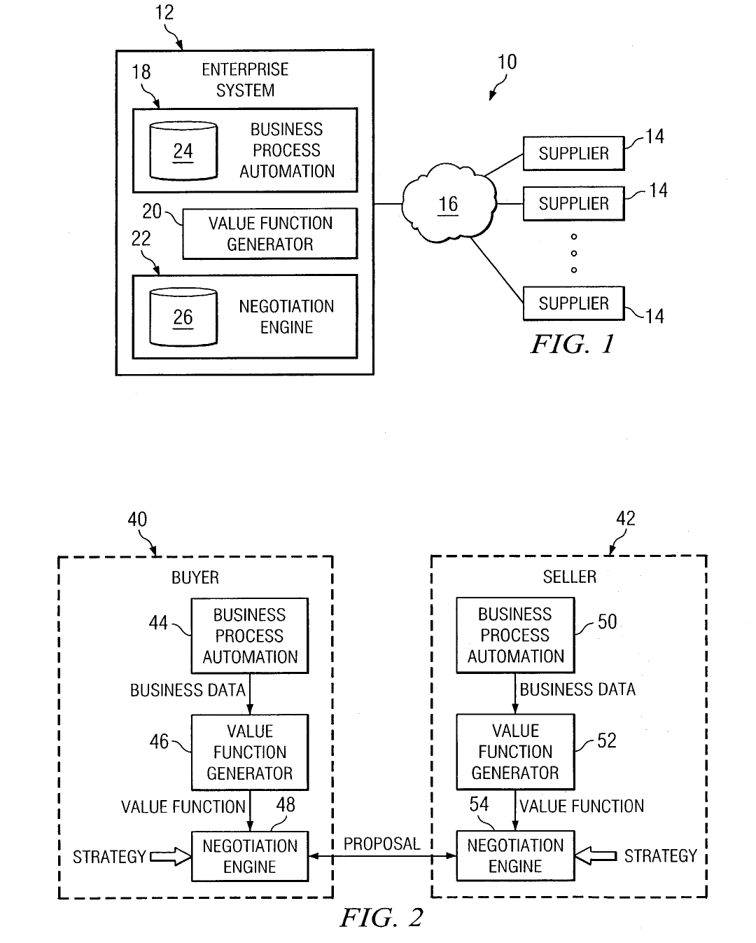

FIG. 1 illustrates a system, indicated generally at 10, for supporting automated negotiations between various parties. In the embodiment illustrated, system 10 includes an enterprise system 12 and a number of suppliers 14 interconnected by a communication network 16. In general, system 10 enables potential transaction partners to perform negotiations using an automated, iterative process. According to particular embodiments, parties negotiate by exchanging multiple proposals in an iterative process, with each proposal potentially including multiple negotiable parameters. For example, enterprise system 12 may negotiate terms of a transaction using multi-parameter, multi-proposal automated negotiations with one or more suppliers 14.

System 10, as illustrated, provides examples of parties that may participate in automated negotiations. These parties include enterprise system 14 and suppliers 14. Enterprise system 12 represents any suitable collection and arrangement of elements managed by an organization to perform various information gathering and processing tasks. These elements include computing devices for performing automated negotiation with other appropriately enabled devices. For example, enterprise system 12 may represent the information tracking and automated negotiation devices of a manufacturer. Like enterprise system 12, each supplier 14 represents any suitable combination and arrangement of elements supporting the information management and automated negotiation capabilities of an organization. For example, each supplier 14 may provide information tracking and automated negotiation for a supplier of components that may be used by enterprise system 12. Therefore, the particular embodiment illustrated provides an example of a buyer (enterprise system 12) with access to multiple sellers (suppliers 14) through communication network 16. However, it should be understood that the particular example illustrated and described is provided for illustrative purposes and that the automated negotiation techniques described may be applied to any suitable negotiation scenarios.

To support automated negotiations, enterprise system 12 includes a business process automation (BPA) module 18, a value function generator 20 and a negotiation engine 22. BPA module 18 maintains and provides access to information regarding the operations of enterprise system 12. In the embodiment illustrated, BPA module 18 maintains a business information database 24. Business information database 24 may include data such as sales forecasts, inventory, product offerings, orders, raw material stocks, commodity prices, and/or any other suitable information that may impact the business operations of enterprise system 12. Moreover, while illustrated as a database maintained within BPA module 18, business information database 24 may represent any suitable distributed information sources. For example, BPA module 18 may locally maintain internal business information, such as inventory and sales forecasts, while accessing remote and/or third party information sources for other information, such as commodity prices.

Value function generator 20 creates value functions for evaluating proposals during an automated negotiation process. For example, value function generator 20 may generate an equation that determines a numerical value for a given proposal based upon one or more terms in the proposal. To generate a value function, value function generator 20 may autonomously analyze information from BPA module 18 or may solicit input from human operators or other sources. By accessing information from BPA module 18, value function generator 20 can gauge the relative importance of various parameters in proposals. For example, based upon the inventory levels of a component necessary for building a finished product, value function generator 20 can craft a value function that places a priority on preventing a shortage of that component. Thus, in this example, the resulting value function may place a higher value on proposals for delivery of the components before a date when the current inventory is projected to be depleted. The value function created by value function generator 20 can include static and/or dynamic terms. For example, a value function may include static functions that evaluate terms using set operations. However, a value function may include dynamic functions that evaluate terms based on the value of the terms in addition to other information, such as updated business data from BPA module 18.

Negotiation engine 22 couples to network 16, locates potential partners for a transaction, and performs automated negotiation of proposals for the transaction. To perform these negotiations, negotiation engine 22 uses an iterative process to exchange multiple proposals with one or more remote negotiation engines. For example, negotiation engine 26 may contact one or more negotiation engines within suppliers 14 and carry out automated negotiations with these remote negotiation engines. Therefore, while the embodiment illustrated only shows specific modules within enterprise system 12, system 10 contemplates other negotiation parties, such as suppliers 14, including modules that provide similar functionality. Thus, for example, each supplier 14 may include modules such as BPA module 18, value function generator 20, and negotiation engine 22.

During negotiations, negotiation engine 22 exchanges proposals with one or more negotiation engines of suppliers 14. Each of these proposals includes one or more terms related to a proposed transaction. For example, for a potential purchase of memory chips, an initial proposal from negotiation engine 22 may specify a type of chip and a quantity. For each term in a proposal, negotiation engine 22 may also include an associated status. According to particular embodiments, this status indicates whether a term is currently unspecified, proposed, or accepted. For example, the status for a delivery date term, in an initial proposal, may indicate that the term is currently unspecified. In a response, supplier 14 may fill in a date for delivery and change the status of the term to proposed. If the proposed date is acceptable to enterprise system 12, negotiation engine 22 can then change the status to accepted. Thus status, in general, enables parties to negotiate and fix terms of a proposal.

In addition to associating status with terms, negotiation engines may support additional tags related to terms in a proposal. According to particular embodiments, negotiation engines also can associate and interpret tags that specify parameter types, acceptable values, and indicate desired actions related to a term. For example, a parameter type indicator may specify whether a term is characterized by continuous values or discreet values. A price term is an example of a continuous parameter, while a memory type is an example of a discreet parameter. To specify acceptable values for a term, the term may have associated tags indicating information such as a range of acceptable values, a list of acceptable values, or any other suitable indicator of acceptable values for a term. Negotiation engine 22 may also associate a desired actions indicator that specifies or requests actions with respect to an associated term. For example, for a price term having a current value, negotiation engine 22 may associate a tag that requests a lower price.

Thus, as these particular examples illustrate, system 10 contemplates parties to an automated negotiation using indicators associated with terms of a proposal to support the automated negotiation process. However, while specific types of indicators are described above, system 10 contemplates parties to an automated negotiation using any suitable indicators associated with terms of the proposals.

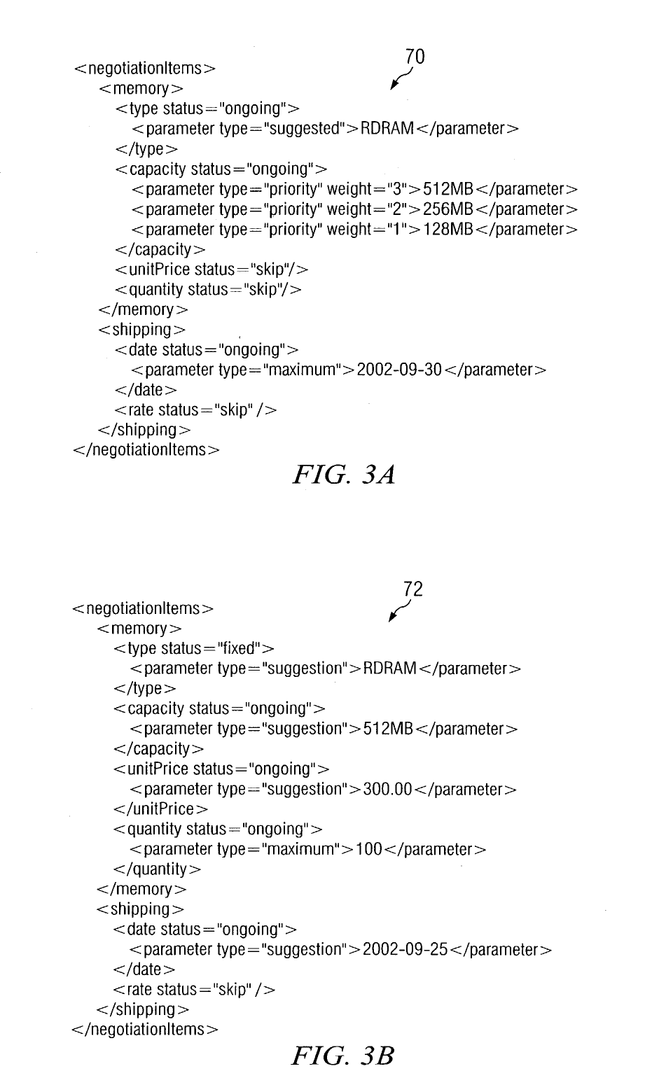

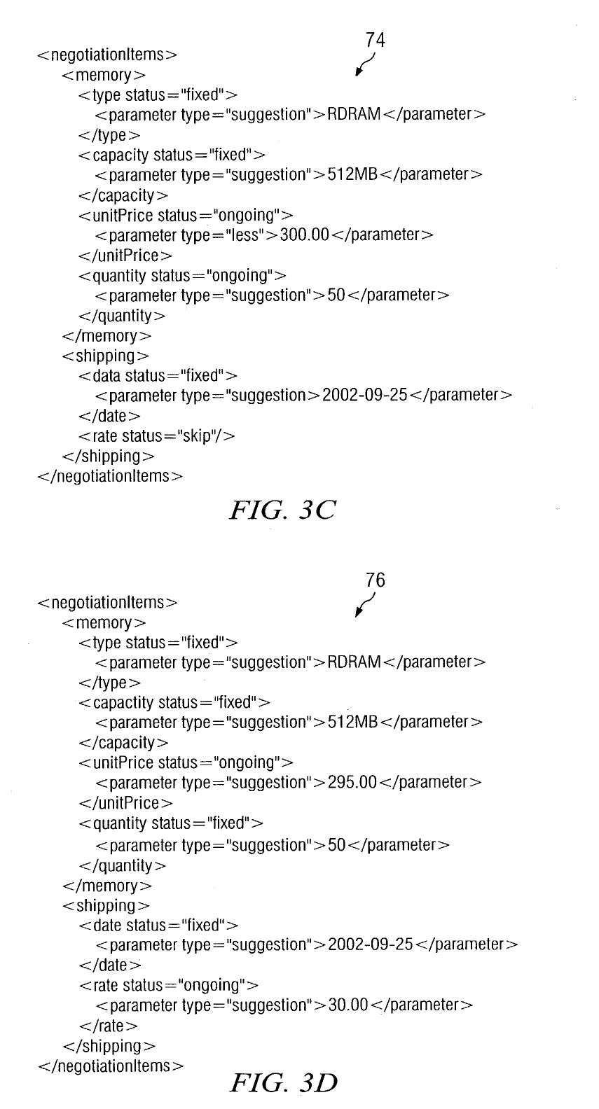

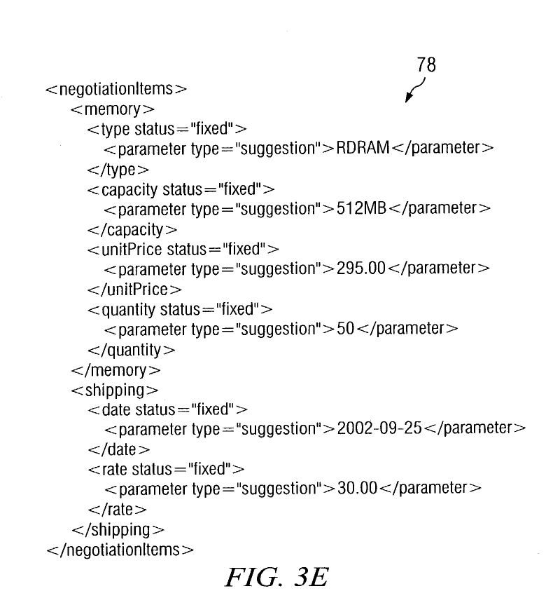

According to particular embodiments, negotiation parties use text based proposals during an automated negotiation process. In particular, parties may use an extensible mark-up language (XML) schema that is specially extended to support automated negotiations. For example, an XML schema can be extended by adding particular tags for indicating information such as status, type, acceptable values, and desired actions. Particular examples of extensions to an XML schema are provided below with respect to FIGS. 2 and 3.

Before automated negotiations between enterprise system 12 and one of suppliers 14 may begin, the parties first may decide upon boundaries for the automated negotiations. These boundaries may include parameters such as how long a negotiation session will last and how long proposals remain valid. To establish these negotiation rules, the parties may use the automated negotiation process as described above. Therefore, before actually negotiating proposals for a potential transaction, the parties may initially negotiate terms that will apply to the negotiations and all proposals generated during the negotiation process.

For example, consider negotiation engine 22 of enterprise system 12 tasked with purchasing some quantity of memory chips. After locating an appropriate supplier 14, negotiation engine 22 may generate an initial proposal specifying a request to purchase components and further indicating parameters for a potential negotiation, such as a time limit of five minutes with each proposal valid until the end of the five minute period. Supplier 14 and enterprise system 12 may then use the automated negotiation process to determine appropriate parameters and overarching terms for any subsequent negotiations. After this initial negotiation, enterprise system 12 and supplier 14 can then use the automated negotiation process to negotiate the potential purchase of the memory chips.

However, as previously noted, enterprise system 12 and suppliers 14 are included within system 10 only as examples of parties that may participate in automated negotiations. But while this illustrates specific types of parties to an automated negotiation, system 10 contemplates supporting the automated negotiation techniques for any suitable parties to negotiations.

FIG. 2 is a block diagram illustrating a generic negotiation scenario between a buyer 40 and a seller 42. This illustrates the data flow and interaction between elements of buyer 40 and seller 42. In the embodiment illustrated, buyer 40 includes a BPA module 44, a value function generator 46, and a negotiation engine 48. Similarly, seller 42 includes a BPA module 50, a value function generator 52 and a negotiation engine 54. In general, BPA modules 44, 50, value functions generators 46, 52, and negotiation engines 48, 54 provide functionality similar to that described above with respect to enterprise system 12. For example, within buyer 40, BPA module 44 provides business data that enables value function generator 46 to create a value function that can evaluate proposals based upon the actual business needs of buyer 40. Value function generator 46 supplies this value function to negotiation engine 48. Negotiation engine 48 uses this value function and an appropriate strategy to generate, evaluate, and modify proposals exchanged with negotiation engine 54 of seller 42.

During negotiations, as previously discussed, buyer 40 and seller 42 exchange multiple proposals using negotiation engines 48 and 54. Moreover, these proposals may be implemented using text based communications, such as an extended XML schema. One potential extension, as previously noted, enables the association of a status tag along with a term of a proposal. For example, consider the following excerpt from a proposal:

<capacity status=“ongoing”>

<parameter type=“suggested”>256 MB</parameter>

</capacity>

This excerpt specifies a proposed value of 256 MB for the capacity of a memory device. The status of “ongoing” reflects that the value is specified, but is yet to be accepted. According to particular embodiments, other status values include “skip,” which indicates that a term is currently unspecified, and “fixed,” which indicates that a term is accepted. Other extensions to proposals will be more readily apparent by reference to FIGS. 3A-3E and the following description.

FIGS. 3A, 3B, 3C, 3D and 3E illustrate proposals exchanged between buyer 40 and seller 42 during example negotiations for the potential purchase of memory devices. FIG. 3A illustrates a proposal 70 generated by buyer 40 during the negotiations. Proposal 70 includes terms for specifying the requested product and for specifying shipping terms. To identify the product, the terms include a memory type, memory capacity, price, and quantity. For shipping terms, proposal 70 includes a shipping date and a rate.

For the memory type term, proposal 70 specifies the type as “RDRAM” and indicates the status of this term as “ongoing.” As previously noted, a value of “ongoing” for the status indicates that the value for the term is proposed but not yet accepted. The memory capacity term includes a number of potential discreet values proposed by buyer 40. In specifying these various potential values, buyer 40 also indicates a relative desire for each of the potential values. In this example, buyer 40 assigns a weight of three for 512 MB memory devices, a weight of two for 256 MB memory devices and a weight of one for 128 MB memory devices. Thus the values for this term of proposal 70 indicate the buyer's willingness to purchase different types of memory while specifying preferences among these different potential types. In addition to specifying memory type and capacity, proposal 70 indicates the need for price and quantity terms. For these terms, proposal 70 indicates an associated status of “skip.” As previously discussed, this status value indicates that the price and quantity terms are currently unspecified.

For shipping terms, proposal 70 specifies a shipping date and indicates that this is the last acceptable date for shipping. By associating this indication with the shipping date, proposal 70 indicates a potential range for this continuous parameter. That is, by specifying the shipping date of Sep. 30, 2002, as the “maximum” shipping date, proposal 70 invites seller 42 to propose a shipping date on or before the specified date. In addition to the shipping date term, proposal 70 introduces the shipping rate term, which in this example is currently unspecified.

FIG. 3B illustrates a proposal 72 generated by buyer 42 in response to proposal 70. This proposal includes the identical terms initially proposed by buyer 40, but in proposal 72, seller 42 has modified a number of the values. In proposal 72, seller 42 has accepted the memory type term proposed by buyer 40. Thus, for this term, the associated status is indicated as “fixed.” For the memory capacity term, seller 42 modifies the term to indicate a proposal for 512 MB memory devices. In effect, seller 42 has modified this term to indicate an availability of this type of memory device. For the previously unspecified price and quantity terms, proposal 72 now suggests proposed values for these terms. As such, the associated statuses of these terms are set to “ongoing.”

In the shipping terms, seller 42 modifies the shipping date to a value within the specified range of proposal 70. Because the shipping date specified by seller 42 within proposal 70 has not been accepted, seller 42 maintains the status of this term as “ongoing.” For the shipping rate term, seller 42 does not provide a value. Thus, proposal 72 maintains a “skip” status for the shipping rate.

FIG. 3C illustrates a proposal 74 generated by buyer 40 in response to proposal 72 from seller 42. In proposal 74, buyer 40 accepts the proposed value for memory type and for shipping date. Buyer 40 accepts these terms by modifying the associated status for each term to “fixed.” For the price term, buyer 40 associates a desired action tag, “less,” indicating a request for a lower price on the memory devices. In addition, buyer 40 modifies the quantity term value that was proposed by seller 42.

FIG. 3D illustrates a proposal 76 generated by seller 42 in response to proposal 74 from buyer 40. In proposal 76, seller 42 accepts the value for quantity that was proposed by buyer 40. In addition, seller 42 responds to the desired action of buyer 40 by proposing a lower price. Seller 42 also supplies a shipping rate value for the shipping rate term.

FIG. 3E illustrates a proposal 78 generated by buyer in response to proposal 76 from seller 42. In proposal 78, buyer 40 indicates an acceptance of the proposed values for price and shipping rate. Therefore, in proposal 78, all terms have been accepted by both parties. At this point, buyer 40 may affix a digital signature and/or other suitable authorization indicating a binding acceptance of proposal 78. Buyer 40 may then transmit the binding proposal to seller 42. In response, seller 42 may affix a similar authorization, at which time buyer 40 and seller 42 have successfully negotiated for the purchase of memory devices using an automated negotiation process.

Therefore, the illustrated proposals and accompanying description provide an example of a very short, linear negotiation process between buyer 40 and seller 42. However, because negotiations are automated by computing devices, these automated negotiations will likely be characterized by much greater numbers of proposals that do not necessarily follow a linear progression. For example, even given the relatively few number of terms in this negotiation, buyer 40 and seller 42 may exchange hundreds or thousands of proposals. The number and type of these proposals may be driven to a large extent by the strategies employed by negotiation engine 48 and negotiation engine 54. For example, negotiation engine 48 of buyer 40 may initially explore potential costs for every different type of memory device. Buyer 40 could further explore tradeoffs in pricing based upon different shipping dates and quantities. Thus at some point, buyer 40 may have a large number of potential proposals that it may accept. Using a value function, negotiation engine 48 can select the “best” one of these acceptable proposals.

This type of automated negotiation leverages some of the best attributes of today's computing devices. That is, these negotiations may be characterized by fast, iterative, non-emotional and precise negotiations. This automated negotiation can significantly reduce the cost of negotiations while simultaneously increasing the value of those negotiations to all parties by increasing the number of parameters being negotiated. For example, by concurrently negotiating proposals varying price, quantity, and shipping date, buyer 40 and seller 42 can more easily converge upon common acceptable terms.

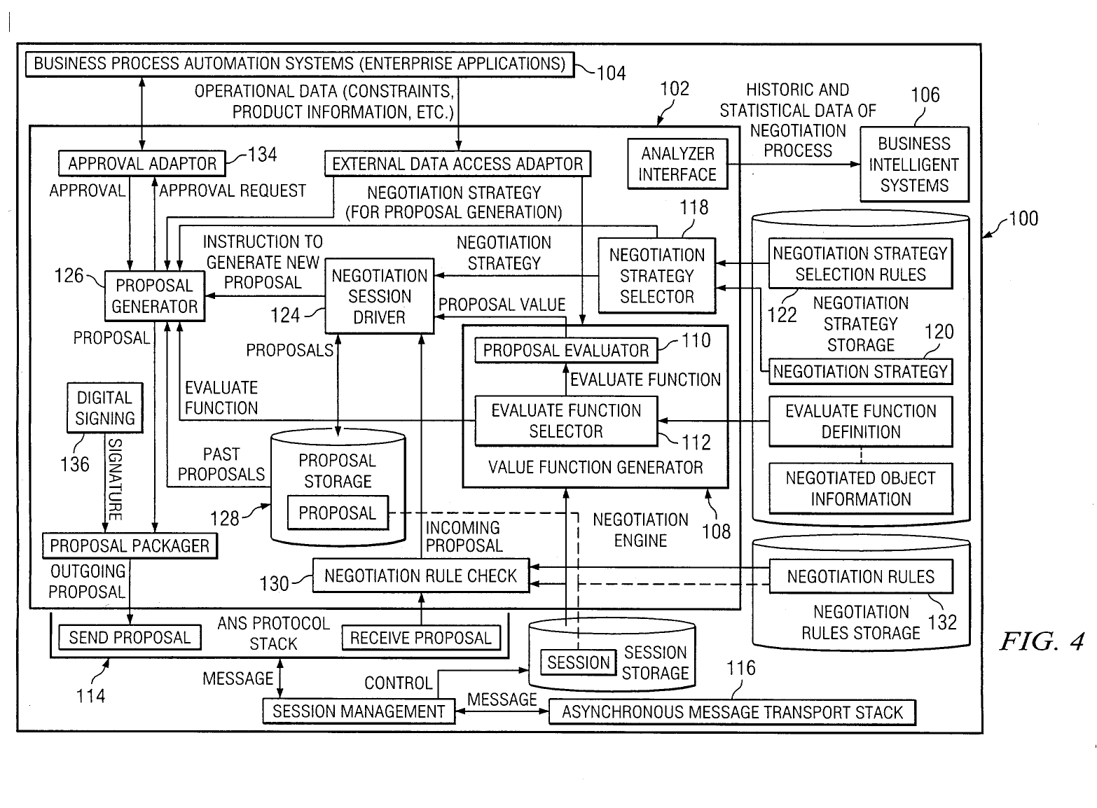

FIG. 4 is a block diagram illustrating in detail potential elements for a negotiation system 100 that may participate as a party in automated negotiations within system 10. Negotiation system 100 includes a negotiation engine 102 that receives business information from enterprise applications 104 to generate and evaluate proposals. For evaluation of proposals, negotiation engine 102 includes a value function generator 108, which encompasses a proposal evaluator 110 and an evaluation function selector 112. For communications with other negotiation parties, negotiation system 100 includes session and interface elements, such as protocol stack 114 and transport stack 116.

For negotiations, negotiation engine 102 uses a negotiation strategy selector 118 to determine an appropriate strategy for the negotiations. For example, negotiation strategy selector 118 may access one or more negotiation strategies 120 and select between these strategies 120 based upon selection rules 122. These strategies 120 may be tailored to various types of negotiations and to the particular side for which negotiations are taking place. For example, for a buyer in a negotiation, the negotiation strategy may attempt to find the lowest price by continually requesting a lower price. Moreover, the strategy may attempt to explore lower price alternatives based on variance of other parameters, such as delivery date, delivery location, and quantity. For a seller, different negotiation strategies may govern. For example, the seller may attempt to use random or pseudo-random changes to values while maintaining some specified profit margin. However, negotiation system 100 contemplates selecting any suitable strategy during negotiations. The selected strategy 120 then drives the operation of a negotiation session driver 124, which determines operations for ongoing negotiations. For example, negotiation session driver 124 may determine various terms to modify and/or propose in each proposal.

Negotiation engine 102 also includes a proposal generator 126 that generates proposals based upon a selected negotiation strategy 120, instructions from negotiation session driver 124, business information, past proposals, and/or other suitable input. For example, proposal generator 126 may modify terms of a proposal received from a remote negotiating party based upon business information and a current selected strategy 120.

During negotiations, negotiation engine 102 may generate and receive any number of proposals. Negotiation engine 102 maintains some or all of these proposals within proposal storage 128. These stored proposals may be used by proposal generator 126 as spring boards for generating new proposals. For example, based upon previously generated and/or received proposals, proposal generator 126 can create modified proposals to explore different options. In addition, any number of the stored proposals may reflect “acceptable proposals” in which all terms can be accepted in a responsive proposal. For example, a proposal from seller 42 may specify a suggested price term and have all other terms indicating a status of accepted. This represents an acceptable proposal, since buyer 40 may accept the proposal by changing the status for the price term to accepted. Thus at any point during negotiations, negotiation session driver 124 may select to accept this or any other acceptable proposals stored within proposal storage 128.

During negotiations, negotiation engine 102 may receive any number of proposals from the other negotiation party. To verify the validity of these proposals, negotiation engine 102 includes a negotiation rule checking module 130. Rule checking module 130 insures the validity of received proposals and insures that these proposals comport with negotiation rules. For example, rule checking module 130 may validate proposals using stored negotiation rules 132 that specify parameters previously negotiated between the parties. Moreover, rule checking module 130 may insure validity of proposals with respect to the basic rules of automated negotiations. For example, rule checking module 130 may insure that a proposal does not indicate an accepted term without the acceptance of both parties.

Before negotiation engine 102 can accept a proposal, human intervention may be required. For example, for transactions that exceed some threshold, such as a price threshold or quantity threshold, negotiation engine 102 may seek human approval. To facilitate this interaction, negotiation engine 102 includes an approval adapter 134. Using approval adapter 134, negotiation engine 102 can interact with human operators to receive approval for making or accepting proposals.

Upon identifying a suitable proposal to accept, negotiation engine 102 can create a signed, accepted proposal. To generate this proposal, negotiation engine 102 includes a digital signing module 136 for affixing an authorization to an accepted proposal. Digital signing module 136 may support any suitable techniques and technology for indicating a binding acceptance of a proposal. However, the particular techniques used by signing module 136 may depend upon previously negotiated contracts, industry standards, legal requirements, and/or other suitable criteria.

As illustrated and described, the elements and data flow within negotiation system 100 provide many of the functionalities for implementing automated negotiations. However, while the embodiment illustrated and the preceding description focus on a particular embodiment of negotiation system 100, system 10 contemplates negotiation system 100 having any suitable combination and arrangement of elements for supporting automated negotiation techniques. Thus, the functionalities performed by the particular elements illustrated may be separated or combined as appropriate, and some or all of these elements may be implemented by logic encoded in media. For example, the functionalities of many of these elements may be implemented by software or other appropriate logic.

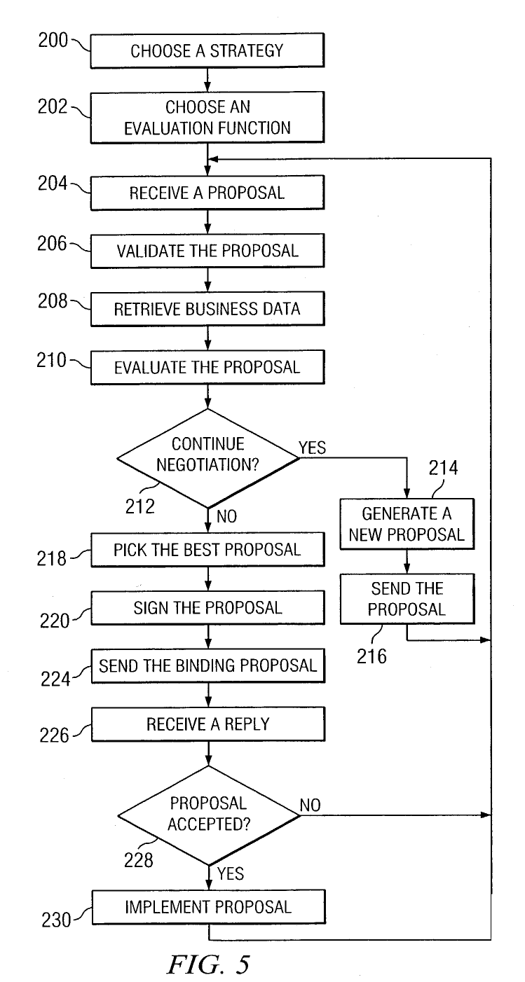

FIG. 5 is a flowchart illustrating a method for performing automated negotiation. The following description of this method will be provided with reference to elements previously described, such as those within negotiation system 100. However, as previously noted, system 10 contemplates negotiating parties using any suitable equipment, including appropriate controlling logic, for performing automated negotiations.

Negotiation system 100 selects a strategy for negotiations at step 200. For example, strategy selector 118 may access a number of strategies 120 and select among these strategies based upon strategy selection rules 122. Negotiation system 100 also selects an evaluation function at step 202. For example, value function generator 108 may access business information, stored value functions, and other appropriate data to generate a value function. This value function, as previously noted, permits negotiation system 100 to evaluate the relative value of various proposals. For example, evaluation function may place a numerical value on a proposal based upon terms within that proposal.

Negotiation engine 102 receives a proposal at step 204 and validates the proposal at step 206. For example, negotiation engine 102 may receive a proposal and validate the proposal using rule checking module 130. Negotiation engine 102 retrieves business data at step 208. For example, negotiation engine 102 may access enterprise applications 104 and/or stored business information to determine data such as current inventory. Negotiation engine 102 evaluates the proposal at step 210. For example, using proposal evaluator 110, negotiation engine 102 may determine a relative valuation of the received proposal. In this evaluation, proposal evaluator 110 may use a static value function and/or a dynamic value function. For example, the value function used by proposal evaluator 110 may dynamically adjust to changes in business information retrieved from enterprise applications 104.

Negotiation engine 102 determines whether to continue negotiations at step 212. Negotiation engine 102 may use any suitable constraints for determining whether or not to continue these negotiations. For example, negotiation engine 102 can determine that a fixed number of iterations have complete, determine that a value function of the currently received proposal has reached a certain value, determine that a difference among evaluated values of currently received proposals has stabilized, or otherwise determine that negotiations should cease. If negotiation system 100 determines to continue negotiations, negotiation engine 102 generates a new proposal at step 214 and sends the proposal at step 216. For example, using proposal generator 126, negotiation engine 102 may modify an existing proposal or generate a new proposal from scratch. The negotiation process repeats in an iterative fashion until negotiation engine 102 decides to halt negotiations.

Upon deciding to stop the iterative negotiations, negotiation engine 102 selects the best acceptable proposal at step 218. For example, using value function generator 108, negotiation session driver 124 may identify the “best” outstanding acceptable proposal. Negotiation engine 102 signs the proposal at step 220 to create a binding proposal, sends the binding proposal at step 224, and receives a reply at step 226. Negotiation engine 102 determines whether the reply accepts the binding proposal at step 228. If not, negotiation engine 102 can restart the iterative negotiation process. If accepted, negotiation system 100 can implement the accepted proposal at step 230. For example, enterprise applications 104 can schedule actions to implement the terms of the accepted proposal.

Therefore, the preceding flowchart illustrates exemplary operation of negotiation system 100 during automated negotiations. However, the preceding flowchart and accompanying description illustrate only an exemplary method of operation, and system 10 contemplates negotiation parties using any suitable techniques to support automated negotiation. Thus, many of the steps in this flowchart may take place simultaneously and/or in different orders than as shown. In addition, negotiation parties may use methods with additional steps, fewer steps, and/or different steps, so long as the methods remain appropriate. For example, this flowchart and the accompanying description do not explicitly detail operations for failed negotiations, negotiations with multiple parties, or opportunities for human interaction. Thus, for example, negotiation parties may use methods that seek human approval for selected valuation functions, individual proposals during negotiations, and for acceptance of binding proposals.

In addition, although the present invention has been described in several embodiments, a myriad of changes and modifications may be suggested to one skilled in the art, and it is intended that the present invention encompass such changes and modifications as fall within the scope of the present appended claims.

What is claimed is:

1. A method for performing automated negotiations comprising:
determining a value function for evaluating terms for a potential transaction;
generating a plurality of proposals, each of the generated proposals specifying terms for the potential transaction, with each of the terms having an associated status;
communicating the generated proposals to a remote negotiation party;
receiving a plurality of proposals from the remote negotiation party, each of the received proposals specifying terms for the potential transaction, with each of the terms in the received proposals having an associated status;
identifying one or more acceptable ones of the received proposals;
evaluating each of the acceptable proposals using the value function to determine relative values for each of the acceptable proposals;
selecting one of the identified acceptable proposals based on the relative values;
accepting the selected proposal by modifying the associated status for at least one of the terms in the selected proposal; and
communicating the accepted proposal to the remote negotiation party.

2. The method of claim 1, wherein each of the associated statuses for each of the terms in the generated proposals and the received proposals indicates one of unspecified, proposed, and accepted.

3. The method of claim 1, further comprising:
identifying at least one continuous term for inclusion in one of the generated proposals; and
associating a range indicator with the continuous term in the one generated proposal.

4. The method of claim 1, further comprising:
identifying at least one discrete term for inclusion in one of the generated proposals; and
indicating a plurality of potential values for the discrete term in the one generated proposal.

5. The method of claim 4, further comprising, for each of the potential values, indicating a relative weight for the potential value.

6. The method of claim 1, further comprising:
identifying a desired action indicator associated with one of the terms in one of the received proposals; and
generating one of the generated proposals by modifying the associated one of the terms in accordance with the desired action indicator.

7. The method of claim 1, further comprising:
generating at least one of the generated proposals by modifying values for one or more of the terms in one of the received proposals and modifying one or more of the associated statuses in the one received proposal.

8. The method of claim 1, wherein each of the generated proposals and the received proposals is encoded using an extended XML schema.

9. The method of claim 1, wherein accepting the selected proposal comprises associating a digital signature with the selected proposal.

10. The method of claim 1, further including automated negotiation of negotiation parameters, comprising:
determining a negotiation value function for evaluating terms for a potential negotiation;
generating a plurality of negotiation proposals, each of the generated negotiation proposals specifying terms for the potential negotiation, with each of the terms having an associated status;
communicating the generated negotiation proposals to the remote negotiation party;
receiving a plurality of negotiation proposals from the remote negotiation party, each of the received negotiation proposals specifying terms for the potential negotiation, with each of the terms in the received proposals having an associated status;
identifying one or more acceptable ones of the received negotiation proposals;
evaluating each of the acceptable negotiation proposals using the negotiation value function to determine relative negotiation values for each of the acceptable negotiation proposals;
selecting one of the acceptable negotiation proposals based on the relative negotiation values;
accepting the selected negotiation proposal by modifying the associated status for at least one of the terms in the selected negotiation proposal; and
communicating the accepted negotiation proposal to the remote negotiation party, wherein the terms in the selected negotiation proposal apply to all of the generated proposals and the received proposals during negotiations for the potential transaction.

11. Logic for performing automated negotiations, the logic encoded in media and operable when executed to perform the steps of:
determining a value function for evaluating terms for a potential transaction;
generating a plurality of proposals, each of the generated proposals specifying terms for the potential transaction, with each of the terms having an associated status;
communicating the generated proposals to a remote negotiation party;
receiving a plurality of proposals from the remote negotiation party, each of the received proposals specifying terms for the potential transaction, with each of the terms in the received proposals having an associated status;
identifying one or more acceptable ones of the received proposals;
evaluating each of the acceptable proposals using the value function to determine relative values for each of the acceptable proposals;
selecting one of the identified acceptable proposals based on the relative values;
accepting the selected proposal by modifying the associated status for at least one of the terms in the selected proposal; and
communicating the accepted proposal to the remote negotiation party.

12. The logic of claim 11, wherein each of the associated statuses for each of the terms in the generated proposals and the received proposals indicates one of unspecified, proposed, and accepted.

13. The logic of claim 11, further operable to perform the steps of:
identifying at least one continuous term for inclusion in one of the generated proposals; and
associating a range indicator with the continuous term in the one generated proposal.

14. The logic of claim 11, further operable to perform the steps of:
identifying at least one discrete term for inclusion in one of the generated proposals; and
indicating a plurality of potential values for the discrete term in the one generated proposal.

15. The logic of claim 14, further operable to perform the steps of, for each of the potential values, indicating a relative weight for the potential value.

16. The logic of claim 11, further operable to perform the steps of:
identifying a desired action indicator associated with one of the terms in one of the received proposals; and
generating one of the generated proposals by modifying the associated one of the terms in accordance with the desired action indicator.

17. The logic of claim 11, further operable to perform the steps of:
generating at least one of the generated proposals by modifying values for one or more of the terms in one of the received proposals and modifying one or more of the associated statuses in the one received proposal.

18. The logic of claim 11, wherein each of the generated proposals and the received proposals is encoded using an extended XML schema.

19. The logic of claim 11, wherein accepting the selected proposal comprises associating a digital signature with the selected proposal.

20. The logic of claim 11, further operable, to perform automated negotiation of negotiation parameters, to perform the steps of:
determining a negotiation value function for evaluating terms for a potential negotiation;
generating a plurality of negotiation proposals, each of the generated negotiation proposals specifying terms for the potential negotiation, with each of the terms having an associated status;
communicating the generated negotiation proposals to the remote negotiation party;
receiving a plurality of negotiation proposals from the remote negotiation party, each of the received negotiation proposals specifying terms for the potential negotiation, with each of the terms in the received proposals having an associated status;
identifying one or more acceptable ones of the received negotiation proposals;
evaluating each of the acceptable negotiation proposals using the negotiation value function to determine relative negotiation values for each of the acceptable negotiation proposals;
selecting one of the acceptable negotiation proposals based on the relative negotiation values;
accepting the selected negotiation proposal by modifying the associated status for at least one of the terms in the selected negotiation proposal; and
communicating the accepted negotiation proposal to the remote negotiation party, wherein the terms in the selected negotiation proposal apply to all of the generated proposals and the received proposals during negotiations for the potential transaction.

21. A system for performing automated negotiations comprising:
means for determining a value function for evaluating terms for a potential transaction;
means for generating a plurality of proposals, each of the generated proposals specifying terms for the potential transaction, with each of the terms having an associated status;
means for communicating the generated proposals to a remote negotiation party;
means for receiving a plurality of proposals from the remote negotiation party, each of the received proposals specifying terms for the potential transaction, with each of the terms in the received proposals having an associated status;
means for identifying one or more acceptable ones of the received proposals;
means for evaluating each of the acceptable proposals using the value function to determine relative values for each of the acceptable proposals;
means for selecting one of the identified acceptable proposals based on the relative values;
means for accepting the selected proposal by modifying the associated status for at least one of the terms in the selected proposal; and
means for communicating the accepted proposal to the remote negotiation party.

22. A method for performing automated negotiations comprising:
determining a negotiation value function for evaluating terms for a potential negotiation;
exchanging a plurality of negotiation proposals with a remote negotiation party, each of the negotiation proposals specifying terms for the potential negotiation, with each of the terms having an associated status;
identifying one or more acceptable ones of the negotiation proposals;
evaluating each of the acceptable negotiation proposals using the negotiation value function to determine relative negotiation values for each of the acceptable negotiation proposals;
selecting one of the acceptable negotiation proposals based on the relative negotiation values;
accepting the selected negotiation proposal by modifying the associated status for at least one of the terms in the selected negotiation proposal;
communicating the accepted negotiation proposal to the remote negotiation party;
determining a transaction value function for evaluating terms for a potential transaction;
exchanging a plurality of transaction proposals with the remote negotiation party, each of the transaction proposals specifying terms for the potential transaction, with each of the terms having an associated status, wherein the terms in the selected negotiation proposal apply to all of the transaction proposals;
identifying one or more acceptable ones of the received transaction proposals;
evaluating each of the acceptable transaction proposals using the transaction value function to determine relative transaction values for each of the acceptable transaction proposals;
selecting one of the acceptable transaction proposals based on the relative transaction values;
accepting the selected transaction proposal by modifying the associated status for at least one of the terms in the selected transaction proposal; and
communicating the accepted transaction proposal to the remote negotiation party.
